(19) United States
(12) Patent Application Publication
(10) Pub. No.: US 2007/0119487 A1
(43) Pub. Date: May 31, 2007

(54) Liquid dispenser for steam cleaner

(76) Inventors: Harold Roy Taylor, Stratford, CT (US); Vito James Carlucci, Stratford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/601,506

(22) Filed: Nov. 17, 2006

Related U.S. Application Data
(60) Provisional application No. 60/738,145, filed on Nov. 18, 2005.

(51) Int. Cl. B08B 3/00

(52) U.S. Cl. 134/134

(57) ABSTRACT

There is provided a liquid dispenser to be used with a steam-cleaning device that enables a user to dispense a heated liquid, such as a cleaning fluid, soap or detergent while simultaneously steam-cleaning. This can be accomplished through the use of a main housing, a base, a housing connection aperture, and a sponge. The preferred embodiment features the main housing capable of easily being connected to the base in a bayonet type coupling for a quick, removable connection. The housing has a reservoir that can be filled with a liquid, such as a cleaning fluid, soap or detergent. The steam-cleaning device can be operated to send steam though the liquid dispenser. As the steam travels through the liquid dispenser, the steam heats up the liquid in the housing reservoir for a more effective cleaning. The liquid can flow to the sponge through a number of minute holes in the base to the surface of the object to be cleaned.

### CROSS-REFERENCE TO RELATED APPLICATIONS

This application claims priority to U.S. Provisional Patent Application Ser. No. 60/738,145 filed on Nov. 18, 2005, incorporated herein by reference in its entirety.

### BACKGROUND OF THE INVENTION

1. Field of the Invention

The present invention relates to devices for steam cleaning. More particularly, the present invention relates to a liquid dispenser that attaches to a steam cleaner to dispense a liquid, such as a cleaning fluid, while simultaneously steam cleaning.

2. Description of Related Art

It is known to provide devices that can be used to clean objects with steam. A pressure vessel can be used to hold a quantity of water. A heater can be used to heat the water to a temperature sufficient to convert at least a portion of the water to steam. A trigger can then be pressed in order to open a valve, which can then enable the steam to flow out through a nozzle toward an object to be cleaned.

Inherent shortcomings associated with these known devices include the inconvenience of providing a cleaning fluid at the same time as using the steam cleaner. A user must either apply the cleaning fluid to an area first and then steam clean the area or vice versa. There is a need for a device that can enable a user to easily apply a cleaning fluid and steam to an area simultaneously.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a liquid dispenser to be used with a steam-cleaning device that enables a user to dispense a heated liquid, such as a cleaning fluid, soap or detergent, for example, while simultaneously steam-cleaning. This can be accomplished through the use of a main housing, a base, a housing connection aperture, and a sponge.

The preferred embodiment features the main housing capable of easily being connected to the base in a bayonet type coupling for a quick, removable connection. The housing has a reservoir that can be filled with a liquid, such as a cleaning fluid, soap or detergent. The steam-cleaning device can be operated to send steam though a hose to an attachment connector and into the liquid dispenser. The steam flows through an attachment protrusion and into a housing passageway via a housing connection aperture. The steam then flows though a base opening and past the sponge aperture to the surface of the object to be cleaned.

As the steam travels through the housing passageway, the steam heats up the liquid in the housing reservoir for a more effective cleaning. The liquid can flow to the sponge through a number of minute holes in the base. The holes can be sized whereby the liquid in the housing reservoir will run out at approximately the same time that the water in the tank of the steam-cleaning device runs out so that both can be refilled at the same time.

### BRIEF DESCRIPTION OF THE DRAWINGS

The present invention is more fully understood by reference to the following detailed description of an illustrative embodiment with the drawings identified below.

FIG. 1 is a perspective view of a liquid dispenser and associated steam-cleaning device in accordance with a preferred embodiment of the present invention.

FIG. 2 is a perspective view of the liquid dispenser of FIG. 1, showing a close-up view of the liquid dispenser and steam-cleaner connector in accordance with a preferred embodiment of the present invention.

FIG. 3 is a perspective view of the liquid dispenser shown in FIG. 1, in accordance with a preferred embodiment of the present invention.

FIG. 4 is a perspective view of the liquid dispenser and hose attachment connector shown in FIG. 1, in accordance with a preferred embodiment of the present invention.

FIG. 5 is a perspective view of the liquid dispenser, showing the bottom of the housing 12, including housing reservoir, and the top of the base, in accordance with a preferred embodiment of the present invention.

FIG. 6 is a bottom perspective view of the liquid dispenser, including the sponge, in accordance with a preferred embodiment of the present invention.

FIG. 7A is bottom view of liquid dispenser, without the sponge.

FIG. 7B is side view of the liquid dispenser, without the sponge.

### DETAILED DESCRIPTION OF THE INVENTION

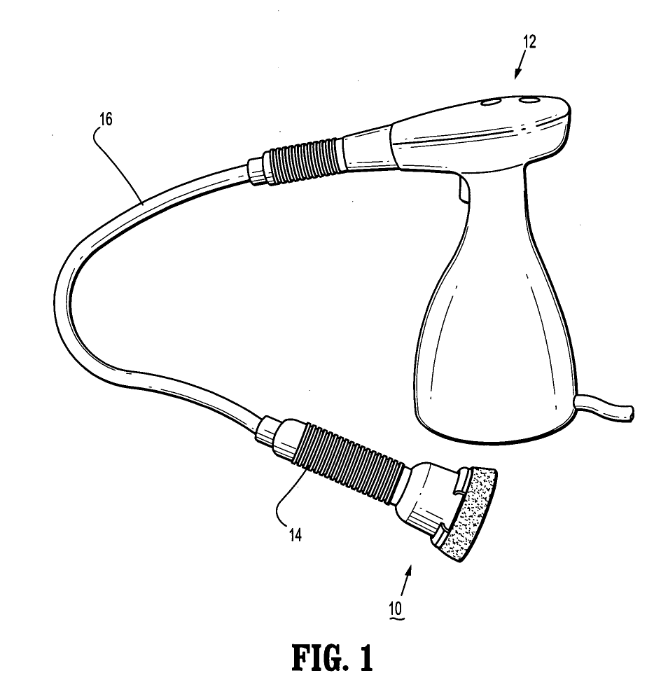

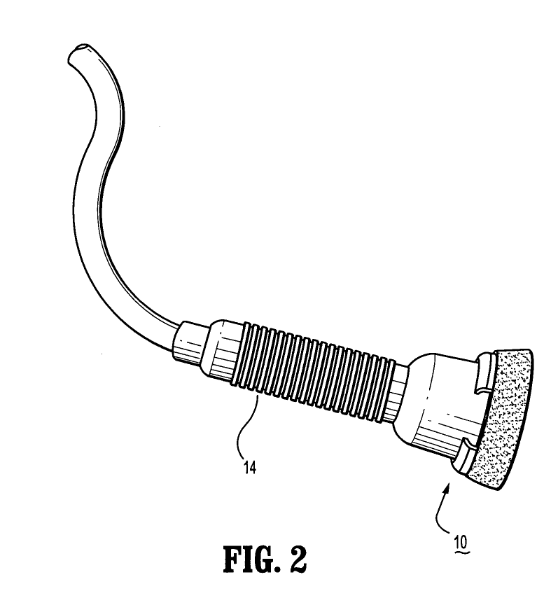

FIGS. 1 and 2 show a liquid dispenser 10 and associated steam-cleaning device 12 in accordance with a preferred embodiment of the present invention. An attachment connector 14 connects a hose 16 from a steam-cleaning device 12 to the liquid dispenser 10. The liquid dispenser 10 enables a user to dispense a liquid, such as a cleaning fluid (e.g., Lysol brand, etc.), soap or detergent, for example, while simultaneously steam-cleaning.

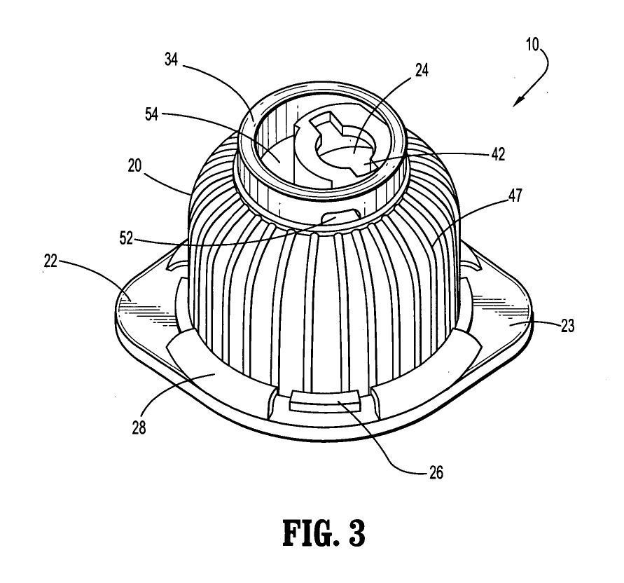

FIGS. 3-5 show the preferred embodiment for the liquid dispenser 10, which includes a main housing 20, a base 22, a housing connection aperture 24, and a sponge 25. Preferably, the main housing 20 has a generally dome-like shape. However, any ergonomic shape may be utilized. In one embodiment, the base 22 can have extensions 23 that provide a user with an easier method of holding the base 22. These base extensions 23 would preferably be located at opposite ends of the base 22.

Preferably, the main housing 20 can be connected to the base 22 in a bayonet type coupling for a quick, removable connection. The housing 20 can be rotated so that tabs 26 can be swiveled under lips 28 on the base 22 so that the tabs 26 are obstructed by the lips 28. This locks the housing 20 and base 22 together. To disconnect one from the other, the housing 20 is rotated in the opposite direction to rotate the tabs 26 out from under the lips 28. The housing 20 can then be easily pulled apart from the base 22. This enables a user to easily refill the housing 20 with a liquid at any time. In one embodiment, the housing 20 has four tabs 26 and the base 22 has four lips 28. However, any number of tabs 26 and lips 28 may be used. Alternate embodiments for temporarily connecting the housing 20 and base 22 together may include latches, springs or any other non-permanent fasteners. In an alternate embodiment, the housing 20 may be filled with a liquid via a fill hole (not shown) in the housing 20.

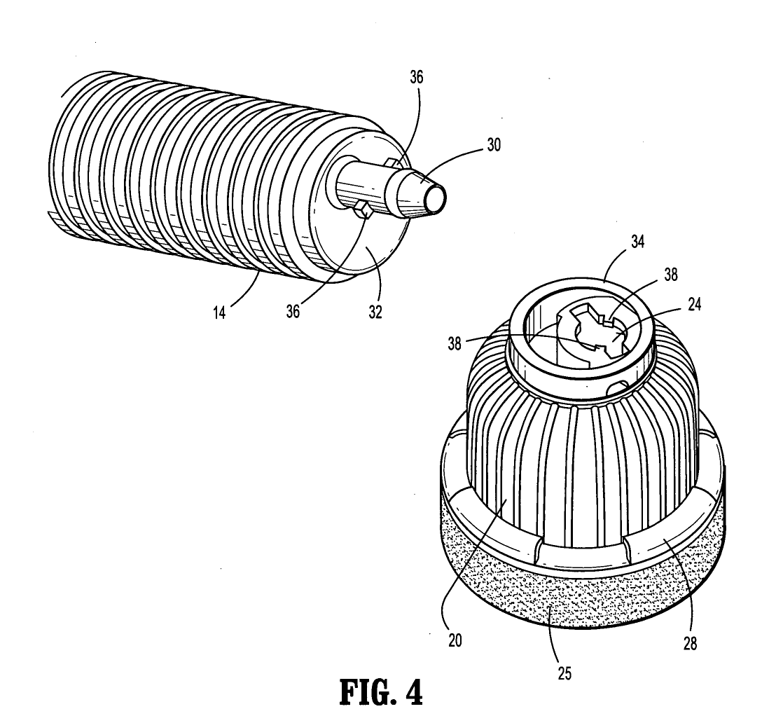

In the preferred embodiment, the attachment connector 14 is connected to the housing 20 by a connector protrusion 30, as seen in FIG. 4. The protrusion 30 enters the housing connection aperture 24 to where the outer wall 32 of the attachment connector 14 butts up against the upper rim 34 of the housing 20. The attachment connector 14 is then rotated so that the protrusion knobs 36 are rotated under the flanges 38 of the connection aperture 24. This provides a bayonet type connection similar to the housing 20 and base 22 connection. To detach, the attachment connector 14 from the housing 20, the attachment connector 14 is rotated in the opposite direction, and the two 14, 20 can be easily separated from one another.

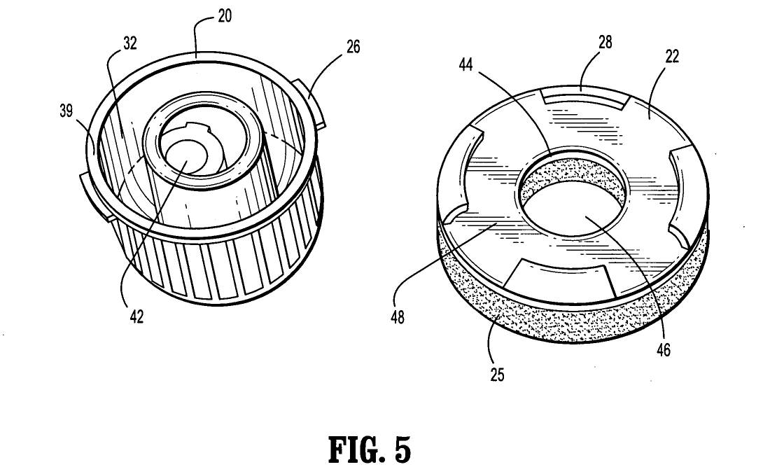

FIG. 5 shows the housing 20 separated from the base 22. The housing 20 preferably has a reservoir 40 that can be filled with a liquid, such as a cleaning fluid, soap or detergent. The housing 20 can then be reconnected to the base in the bayonet type connection described above. A seal 39 can be used to prevent the liquid from leaking out of the housing 20. The housing 20 and base 22 connection can then be attached to the attachment connector 14 in the manner previously described.

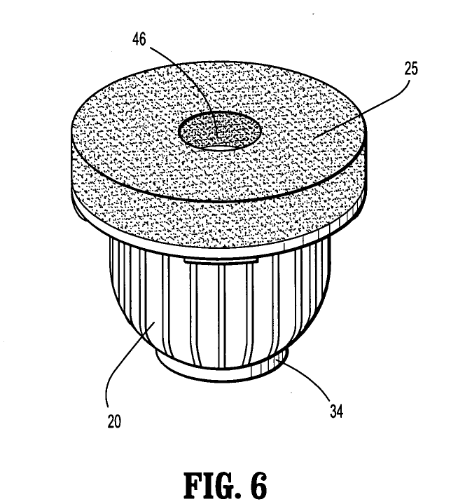

The steam-cleaning device 12 can then be operated to send steam though the hose 16 to the attachment connector 14 and into the liquid dispenser 10. The steam flows through the attachment protrusion 30 and into the housing passageway 42 via the housing connection aperture 24. The steam then flows though the base opening 44 and past the sponge aperture 46, seen in FIGS. 5 and 6, to the surface (not shown) of the object to be cleaned.

As the steam travels through the housing passageway 42, the steam heats up the liquid in the housing reservoir 40. Many liquids, in the form of cleaning fluids, detergents, etc., are more effective at a temperature higher than room temperature. Certain cleaning fluids have an optimum working temperature of approximately 120 degrees Fahrenheit, for example. In a preferred embodiment, a plurality of ribs 47 can extend from the outer surface of the housing 20 to enable a user to grasp the housing 20 so that the high temperature of the liquid does not cause discomfort to the user. These ribs 47 provide a space between the outer wall of the housing 20 and the user's fingers should the user to desire to refill or alternate liquids within the reservoir 40. In one embodiment, these ribs 47 can be a series of generally parallel lines. However, they can be in the form of a variety of geometric patterns or shapes and be fabricated to have a higher density than the surface of the housing, if desired.

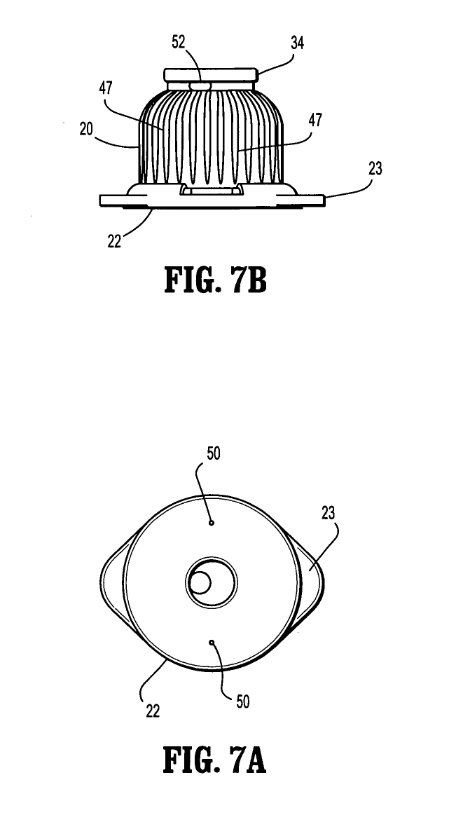

From the top wall 48 of the base 22 and passing through the base, one or more liquid holes 50 enable the liquid to pass from the housing reservoir 40 to the sponge 25. These holes 50, seen in FIG. 7A, can be minute in size to allow a small amount of liquid at a time to flow into the sponge 25. In the preferred embodiment, the base 22 has two liquid holes 50 at opposite ends of the base 22. However, the base 22 can have any number of holes at any of a variety of locations on the base 22. The holes 50 can be in a predetermined pattern or can be located in a random manner in the base 22.

In a preferred embodiment, the holes 50 are sized to work in conjunction with the tank of water (not shown) in the associated steam-cleaning device 12, whereby the liquid in the housing reservoir 40 will run out at approximately the same time that the water in the tank of the steam-cleaning device 12 runs out. As such, a user will only need to stop once to refill both rather than having to refill the housing reservoir 40 and the water tank at different times. This will save the user time and effort. The size of the holes 50 can be determined by the type of liquid likely to be used. The thicker the liquid, the slower it will flow through the holes. In an alternate embodiment, the liquid dispenser could come with more than one base 22, where each base 22 could have different size holes. This would enable a user to choose one of several bases, depending on the type of liquid to be placed in the reservoir 40. The bases could be labeled or color-coded for different liquids to be used.

The liquid dispenser 10 preferably has a safety system incorporated in the form of exit holes 52, as seen in FIGS. 3 and 7B, and a steam overflow section 54 that runs adjacent to the housing passageway 42. The exit holes 52 and steam overflow section 54 provide a route for the steam to flow should the housing passageway 42 become obstructed for any reason. The housing passageway 42 could possibly become blocked due to an object or due to a mineral deposit, such as a calcium buildup from hard water, for example. The excess steam would have a backup exit through the exit holes 52 to prevent the steam from traveling back up the attachment connector 14 and/or hose 16 where the hot steam might be expelled toward the face or body of a user. The steam overflow section 54 provides an initial space for the steam to flow so that the steam does not cause a pop or other disruption if instantly attempting to exit through the exit holes 52.

While a preferred embodiment of the invention has been herein disclosed and described, it is understood that various modifications can be made without departing from the scope of the invention.

What is claimed is:

1. A liquid dispenser for a steam cleaner comprising:
a housing for containing a liquid having a housing passageway generally though the center of said housing;
a base connected to said housing having a base opening generally though the center of said base; and
a sponge connected to said base having a sponge aperture generally through the center of said sponge;
wherein said housing passageway, said base opening and said sponge aperture are at least partially aligned to enable steam to pass completely though said liquid dispenser.

2. A liquid dispenser according to claim 1, wherein
said base further comprises at least one liquid hole to enable said liquid to flow from said housing to said sponge.

3. A liquid dispenser according to claim 2, wherein
said steam passes through said liquid dispenser while simultaneously said liquid flows from said housing to said sponge.

4. A liquid dispenser according to claim 3, wherein
said steam heats up said liquid as said steam passes through said liquid dispenser.

5. A liquid dispenser according to claim 3, wherein
said at least one liquid hole has a size that causes said liquid from said housing to be depleted at approximately the same time as said steam is depleted from said steam cleaner.

6. A liquid dispenser according to claim 1, further comprising
an attachment connector to connect a hose from said steam cleaner to said liquid dispenser to enable steam to be propelled from said steam cleaner to said liquid dispenser.

7. A liquid dispenser according to claim 1, further comprising
at least one tab on said housing to enable said housing to be selectively connected to said base in a removable bayonet-type coupling.

8. A liquid dispenser according to claim 1, further comprising
a plurality of ribs on the outer surface of said housing.

9. A liquid dispenser according to claim 1, wherein
said housing has a generally dome shape.

10. A liquid dispenser according to claim 1, wherein
said base has a seal around the outside circumference to prevent liquid from leaking out of said housing.

11. A liquid dispenser according to claim 1, further comprising
a safety system to provide a route for said steam if the housing passageway becomes obstructed.

12. A liquid dispenser according to claim 1, wherein
said base further comprises base extensions to enable a user to more easily grasp said base.
